(19) United States
(12) Patent Application Publication
(10) Pub. No.: US 2018/0029947 A1
(43) Pub. Date: Feb. 1, 2018

(54) ACTIVATED AEROBIC COMPOSTING MEDIA AND PRODUCTION METHOD THEREOF

(71) Applicant: Omega Ecotech Products India Pvt Ltd., Coimbatore (IN)

(72) Inventors: Joshy V. Cherian, Coimbatore (IN); P. Thamizhchelvan, Coimbatore (IN)

(21) Appl. No.: 15/283,898

(22) Filed: Oct. 3, 2016

(30) Foreign Application Priority Data
Jul. 28, 2016 (IN) 201641025817

(51) Int. Cl. C05F 17/00

(52) U.S. Cl. CPC C05F 17/0036

(57) ABSTRACT

The present invention provides an activated aerobic composting media comprising of, coir pith, nutritive amendments and consortium of micro-organism, for rapid composting of organic waste into high-quality organic manure. The composting media of the present invention has excellent water retention property, optimum pH and air-water balance for enabling efficient biodegradation and eliminates the need of frequent turning or frequent watering of the organic material during composting. The present invention also provides a method of preparation of the media and compacting it for easy packaging, transportation, storage, and handling. The compacted composting media of the present invention provides a hassle free, cost effective and convenient composting process, which results in a odour-free, leachate-free composting of organic waste without producing any toxic gases.

### FIELD OF INVENTION

The present invention relates to a composting media and process of production thereof. More specifically, the present invention is directed towards the production of activated aerobic composting media containing coir pith amended with nutritive amendments, and consortium of microorganism cultures used therein, for providing high quality organic compost with pleasant odour and easy to handle properties.

### BACKGROUND OF THE INVENTION

Conventionally, there exists a variety of ways for the disposal of the organic wastes, easiest way includes incineration and dumping it as a land-fill. Incineration results in emission of greenhouse gases which is of environmental concern and also requires the disposal of resultant ashes, furthermore, the initial costs involved in setting-up an incineration unit is very expensive. While the dumping of waste as land-fill holds serious environmental problems such as pollution of the ground water, gas emission, leachate, foul odor, contamination, dissemination etc. Another simple yet efficient method of disposal of organic waste is by composting. Composting is a biological decomposition and stabilization of organic material to produce a stable humic rich substance known as compost, which can be used to improve the soil quality as fertilizer and soil conditioner. Composting has a wide range of applications in agriculture, economy, and environment. Composting involves the process of recycling the organic materials by fragmenting, mixing and depositing in a pit and allowing them to sit until they decomposed. In order to achieve optimum conditions such as sufficient oxygen supply, the waste is aerated from time to time by shifting the stacks or mixing the contents, if not the resulting mixture would decompose anaerobically, with strong odors associated therewith. In particular, many organic waste materials disposed from food processing and allied industries are likely to have high water content and improper composting of these may lead to a growth of variety of bacteria including aerobic and anaerobic, this mixed fermentation by anaerobic and aerobic bacteria results in reduced fermentation efficiency and takes several months to decompose and stabilize as compost. Further this may result in putrefaction and unpleasant odors in the resulting compost. In view of eliminating the said problems, composting process using various media, microorganisms and in a controlled environment have been attempted, but none of them resulted in any satisfactory outcome.

In agriculture and farming the by-product of one industry can become a raw material for another industry. Coir pith also known by other names such as coco peat, coir dust, coir fibre pith is one such by-product of coir industry has wide spread applications as recyclable material. Cocos mucifera the Coconut palm yields the fruit Coconut. The Mesocarp of the fruit known as coconut husk is the raw material for the production of coir fiber. During the extraction of the coir fiber from the husk lightweight elastic, cellular, cork like spongy material is released. This non-fibrous tissue of the husk is referred to as coir pith. Particle size of the coir pith various from 0.2 mm to 6 mm. The coir pith with its very high porosity and water holding capacity (500%-600%) provides the best environment for the aerobic fermenting microbes. Several researchers have tried to exploit these properties of the coir pith to bring out few successful value added products.

IN 3714/CHE/2011 provides a new process of aerobic composting of solid and liquid material using a novel application of natural ligno-cellulosic matrix/substrate like coir pith, sawdust, palm leaves, hay etc. This provides the aerobic condition and maintain structural integrity of the matrix. This also absorbs liquid materials preventing leaching and adsorb odor and stench creating gases.

KR 101323907 discloses a soil improving method using cocopeat as a rot material and inoculating the microbial population in the cocopeat. Digging up the soil mixes the cocopeat in which microorganism is inoculated with the soil. The inoculated microbial population comprises mixture of Bacillus subtilis GB03; Paenibacillus polymyxa E681; Bacillus sp. AP162; Aspergillus oryzae, Lactobacillus reuteri, Rhodobacter capsulatus, and Saccharomyces cerevisiae.

KR1020110077703 relates to a method of manufacturing the compost comprising 10-30 volume % of cocopeat, 15-25 volume % of peat, 10-20 volume % of castor meal, 15-25 volume % of rice bran, 1-5 volume % of a microorganism promoter, and remaining palm kernel expeller to improve the productivity of crops. Method for manufacturing the microorganism promoter includes mixing the microorganism with zeolite and solid-cultivated in a fermenter at temperature between 40 and 45 degrees Celsius for 3 to 5 days. Microorganism is selected from photosynthetic bacterium, actinomyces, bacillus, bacillus megaterium, and yeast.

KR1019990040825 provides a method of manufacturing mass production of compost by fermenting waste food with aerobic and anaerobic microbes. The method comprises of: separating other materials such as vinyl and iron from waste food; filling the rotary drum type fermenter with dehydrated waste food and aid-substances selected from bacteria, peat moss, wood chips and cocopeat in a ratio of 20:1-5:1; fermenting at 25-70 deg. C., for 1-2 days under 45-70% of water content, pH 5-9, with rotation at a rate of 1-10 rpm; transferring the fermented wastes into a sealed static fermenter; maturing at 25-70 deg. C. for 7-21 days under 45-70% of water content, pH 5-9. The usable bacteria is at least one selected from aerobic and anaerobic bacteria groups consisting of bacillus sp. lactobacillus acidophilus, cellulomonas sp. and Aspergillus oryzae.

All of the above cited prior-arts describes about composting of dry/dehydrated organic wastes involving different process methods and using varied media and microorganisms, some of the documents describes about the method of using the compost as a soil conditioner. None of the above cited prior-art discusses composting of wet waste which involves undesired conditions such as foul smell, obnoxious leaching, evolution of toxic gases etc. Therefore there exists a need in the art for a simple, efficient, reliable and cost effective composting media for composting both dry and wet organic waste, which can produce a high quality compost to be utilized as a soil improving agent.

The present invention provides an activated aerobic composting media containing coir pith amended with nutritive amendments and consortium of microbial culture used therein for bio-degradation of wet and dry organic waste into excellent high-quality, easy to handle, organic manure. The aerobic composting media can also be used for digesting and degradation of water polluted by organic waste. The present invention also provides a method of producing the said composting media which is compacted that enables easy transportation, packaging, storage and handling of the composting media. The excellent water retention property of the media with optimum air-water balance and microbial consortium used results in complete breakdown of all types of complex organic molecules. The present invention provides a hassle free, cost effective and convenient composting process which is free of obnoxious odour, toxic gases, leaching, and does not require frequent aeration or watering of the waste during fermentation/composting. Further the present invention results in rapid biodegradation of the organic waste into a high quality organic manure with a pleasant odour and convenient handling.

### OBJECTIVE OF THE INVENTION

The primary objective of the present invention is to provide an activated aerobic composting media for biodegradation of the organic waste to produce a high quality organic compost, with pleasant odour and easy to handle properties.

Another objective of the present invention is to provide an activated aerobic composting media with excellent water retention property, optimum pH and optimum air-water balance which enables efficient biodegradation of the organic waste.

Still another objective of the present invention is to provide an activated aerobic composting media which can be compacted, that enables easy transportation, packaging, storage and handling of the media

Yet another objective of the present invention is to provide a method of preparation of the activated aerobic composting media.

Additional objective of the present invention is to provide a hassle free, cost effective and convenient composting process which is free of obnoxious odour, toxic gases and water leaching.

Final objective of the present invention is to effect complete and rapid biodegradation of the organic waste into a high quality organic manure using the activated aerobic media and microorganism cultures used therein.

### SUMMARY OF THE INVENTION

The present invention provides an activated aerobic composting media for rapid composting of the organic waste into high-quality organic manure, comprising of: coir pith in the range of 30-90 wt %; suitable microbial consortium in the range of 2-10 wt %; and one or more nutritive amendments in the range of 0-20 wt %. The microbial consortium is selected from a group of aerobic fermenting microorganisms. The method of preparation of the activated aerobic composting media comprises the steps of: collecting and cleaning the coir pith; drying the coir pith to a pre-determined moisture level; adding required amount of microbial consortium; adding required amount of nutritive amendments; mixing the resulting mixture of coirpith, microbes and nutrients using appropriate mixing equipments; and compressing the resulting mixture of activated aerobic composting media using suitable means into desired shape and size. The composting media of the present invention has excellent water retention property, optimum pH optimum air-water balance for enabling efficient biodegradation of the organic waste. Composting using the activated aerobic composting media of the present invention provides sufficient aeration and buffering eliminating the need of frequent turning or frequent watering of the composting material. Further the present invention provides a rapid, easy and effective composting process without producing any foul odour, liquid leachate and toxic gases.

### DETAILED DESCRIPTION OF THE INVENTION

The present invention as embodied by the “an activated aerobic composting media and production method thereof,” succinctly fulfils the above-mentioned need(s) in the art. The present invention has objective(s) arising as a result of the above-mentioned need(s), said objective(s) being enumerated below. In as much as the objective(s) of the present invention are enumerated, it will be obvious to a person skilled in the art that, the enumerated objective(s) are not exhaustive of the present invention in its entirety, and are enclosed solely for the purpose of illustration. Further, the present invention encloses within its scope and purview, any structural alternative(s) and/or any functional equivalent(s) even though, such structural alternative(s) and/or any functional equivalent(s) are not mentioned explicitly herein or elsewhere, in the present disclosure. The present invention therefore encompasses also, any improvisation(s)/modification(s) applied to the structural alternative(s)/functional alternative(s) within its scope and purview. The present invention may be embodied in other specific form(s) without departing from the spirit or essential attributes thereof.

Throughout this specification, the use of the word “comprise” and variations such as “comprises” and “comprising” may imply the inclusion of an element or elements not specifically recited.

The present invention provides an activated aerobic composting media for composting organic waste into high-quality organic manure comprises of: coir pith; one or more nutritive amendments and consortium of micro-organisms.

Activated aerobic composting media of the present invention is a unique and very efficient aerobic fermentation Media for degrading different types of solid and semi solid biodegradable waste in a short time without any foul smell into excellent organic manure. This media can also remove and digest different bio degradable waste from water polluted by bio degradable waste. The composting media provides an excellent environment for the aerobic microbes to convert the organic material to good quality manure. The composting media ensures optimum air water balance for the most efficient aerobic digestion. The composting media is supplemented with balanced nutrition to ensure the availability of all required nutrients for the most efficient aerobic digestion of biodegradable waste. The composting media is enriched with powerful aerobic compositing microbes like lignolytic, phenolytic, lipolytic, proteolytic, cellulolytic and hemicellulolytic. This consortium approach ensures total breakdown of all types of complex organic molecules in the biodegradable residue available for composting.

The activated aerobic composting media in one of the embodiment is made from the raw material comprising the by-product of the coconut industry namely the coir pith also known as cocopeat. The other raw material includes nutritive amendments and consortium of micro-organisms.

Cocos mucifera the Coconut palm yields the fruit Coconut. 54 billon Coconut are produced annually in the world. The Mesocarp of the fruit known as coconut husk is the raw material for the production of coir fiber. During the extraction of the coir fiber from the husk lightweight elastic, cellular, Cork like spongy material is released. This non-fibrous tissue of the husk is referred to as coir pith. Particle size of the coir pith various from 0.2 mm to 6 mm. The coir pith with its very high porosity and water holding capacity provides the best environment for the aerobic fermenting microbes.

The present invention uses the coir pith obtained from the coconut processing industries of Coimbatore region in Tamilnadu, India.

This invention also suitably includes the use of micro-organisms for the preparation of aerobic composting media. The type and quantity of micro-organisms used is critical for preparing the high quality composting media. use of one or more of the aerobic fermenting microorganism is contemplated for the present invention.

In the preferred embodiment, wherein the said aerobic fermenting micro-organisms used includes micro-organisms selected from the group consisting of but not limited to Pseudomonas putida, Streptomyces olivaceus, Bacillus pumilus, Cellulomonas thermocellum, Bacillus subtilis, Streptococcus bovis, Bacillus licheniformis, Pseudomonas aeruginosa, Bacillus circulans, Lactobacillus acidovorans, Saccharomyces cerevisiae, Pbaffia sp, Azotobacter vinelandii and mixtures thereof.

In the present invention, wherein the source and geographical origin of the said micro-organisms includes Tamilnadu agricultural university (TNAU), coimbatore, TamilNadu; Valparai Soils, Gudalur, Tamil Nadu; Kumily, Thekkady, Kattappana, Kerala; Erode, Gobi, Thanjavur, Nagapattinam, Tamil Nadu; Nashik, Maharashtra; Malbazar, Assam; Mysore, Karnataka.

This invention also suitably includes the use of one or more nutritive amendments for the preparation of aerobic composting media. Addition of nutritive amendments plays an important role in supplying sufficient amount of balanced nutrition to all the different microbes used in the invention and ensures the availability of all the required nutrients for the microbes to result in a most efficient aerobic digestion.

In the preferred embodiment, wherein the said nutritive amendments used includes nutrients selected from the group consisting of but not limited to fructose, protein powder, multi nutrient powder including macro and micro nutrients, oil cakes including castor cake, groundnut cake, neem cake, palm kernel, sachharides, bone meal, jaggery, rock phosphate and mixtures thereof.

In an embodiment of the present invention the method of preparation of the activated aerobic composting media comprises the steps of: collecting the coir pith, a by-product from the coir industry; cleaning the collected coir pith; drying the coir pith to a pre-determined moisture level; adding required amount of microbial consortium; adding required amount of nutritive amendments; mixing the resulting mixture of coirpith, microbes and nutrients using appropriate mixing equipments; and compressing the resulting mixture using suitable means into desired shape and size.

In the preferred embodiment, wherein the said activated aerobic composting media for composting organic waste into high-quality organic manure comprises of 30-90 wt % coir pith, more preferably 30-90 Wt %.

In the preferred embodiment, wherein the said cleaning of the coir pith is performed by solid state aerobic fermentation process, a technology adapted from the pending patent application 1536/CHE/2011 dated 4 May 2011.

In the preferred embodiment, wherein the said coir pith is dried to a moisture level of 10 to 20%, preferably 12-17%.

In the preferred embodiment, wherein the said activated aerobic composting media for composting organic waste into high-quality organic manure comprises of 2-10 wt % microbial consortium, more preferably 4-7 Wt %.

In the preferred embodiment, wherein the said activated aerobic composting media for composting organic waste into high-quality organic manure comprises of 0-20 wt % nutritive amendments, more preferably 0-10 Wt %.

In the preferred embodiment, wherein the said resulting mixture of coirpith, microbial consortium and nutritive amendments is compressed by means of hydraulic pressing into compacted blocks of desired shape and size which enables easy transportation, packaging, storage and handling of the media.

In the preferred embodiment, wherein the pH of the resulting activated aerobic composting media is maintained at 4-8, more preferably at 6-7.5.

In an embodiment of the present invention, the method of composting the organic waste using the said activated aerobic composting media into high-quality organic manure comprises of hydrating the media with sufficient amount of water with respect to the moisture level of the waste, mixing the hydrated composting media with the organic waste and allowing it to ferment for the required time.

In the preferred embodiment, wherein the said activated aerobic composting media at the hydrated state maintains a moisture level of 20 to 60%, more preferably 30 to 60% to accommodate various organic waste with different moisture level.

In the preferred embodiment , wherein the said time required for fermentation and composting the organic waste into high quality manure is preferably 10 to 40 days, more preferably 20 to 35 days.

The method of composting using the activated aerobic composting media of the present invention does not require any frequent turning of the material or frequent watering. Further the present invention provides a rapid, easy and effective composting process without producing any foul odour, liquid leachate and toxic gases.

### Advantages of the Present Invention:

Activated aerobic composting media accelerates the biodegradation of the organic waste and produces high quality organic manure in a very short time.
Eliminates the release of any foul smell. The biodegradable waste which is generating foul smell when introduced into the composting medium losses the foul smell immediately. Hence odor free composting can be achieved using this media.
Eliminates the frequent turning of the composting material, sufficient aeration is produced by the media. This reduces the cost incurred for turning.
Eliminates frequent watering of the composting material. The media has got excellent water retention qualities which maintains the required amount of moisture level in the composting mixture.
The composting media ensures optimum temperature for most efficient composting.
The buffering capacity of the media ensures optimum pH for the most efficient degradation.
The efficient complete breakdown of organic material prevents the possibility of evolution of any unwanted gases like carbon monoxide, Hydrogen Sulphide etc.
A hassle free convenient and odor free composting of organic material allows us the composting of both domestic and industrial organic waste.
The composting media is very cost effective and the composting method does not require any huge capital investment.
The resulting compost after composting the organic waste with the activated aerobic composting media is a high quality organic manure with a pleasant odor and could be handled very conveniently.

1. An activated aerobic composting media for rapid composting of the organic waste into high-quality organic manure, comprising of: coir pith in the range of 30-90 wt %; suitable consortium of micro organisms in the range of 2-10 wt %; and one or more nutritive amendments in the of 0-20 wt %.

2. The activated aerobic composting media according to claim 1, wherein the said coir pith is the by-product of coir industry.

3. The activated aerobic composting media according to claim 1, wherein the said consortium of micro-organisms is selected from a group of aerobic fermenting microorganisms.

4. The activated aerobic composting media according to claim 1, wherein the said aerobic fermenting micro-organisms includes micro-organisms selected from the group consisting of but not limited to Pseudomonas putida, Streptomyces olivaceus, Bacillus pumilus, Cellulomonas thermocellum, Bacillus subtilis, Streptococcus bovis, Bacillus licheniformis, Pseudomonas aeruginosa, Bacillus circulans, Lactobacillus acidovorans, Saccharomyces cerevisiae, Pbaffia sp, Azotobacter vinelandii and mixtures thereof.

5. The activated aerobic composting media according to claim 1, wherein the said nutritive amendments used includes nutrients selected from the group consisting of but not limited to fructose, protein powder, multi nutrient powder including macro and micro nutrients, oil cakes including castor cake, groundnut cake, neem cake, palm kernel, sachharides, bone meal, jaggery, rock phosphate and mixtures thereof.

6. The method of preparation of the activated aerobic composting media comprises the steps of: collecting the coir pith, a by-product from the coir industry;
cleaning the collected coir pith; drying the coir pith to a pre-determined moisture level;
adding required amount of microbial consortium; adding required amount of nutritive amendments; mixing the resulting mixture of coirpith, microbes and nutrients using appropriate mixing equipments; and compressing the resulting mixture of activated aerobic composting media using suitable means into desired shape and size.

7. The method of preparation of the activated aerobic composting media according to claim 6, wherein the said coir pith ranges from 30-90 wt % of the composting media, more preferably 70-90 Wt %.

8. The method of preparation of the activated aerobic composting media according to claim 6, wherein the said coir pith is dried to a moisture level of 10 to 20%, preferably 12-17%.

9. The method of preparation of the activated aerobic composting media according to claim 6, wherein the said microbial consortium ranges from 2-10 wt % of the composting media, more preferably 4-7 Wt %.

10. The method of preparation of the activated aerobic composting media according to claim 1, wherein the said nutritive amendments ranges from 0-20 wt % of the composting media, more preferably 0-10 Wt %.

11. The method of preparation of the activated aerobic composting media according to claim 6, wherein the said resulting composting media, containing mixture of coir pith, microbial consortium and nutritive amendments, is compressed by means of hydraulic pressing into compacted blocks of desired shape and size, which enables easy transportation, packaging, storage and handling of the media.

12. The activated aerobic composting media according to claim 1, wherein the pH of the composting media is maintained at 4-8, more preferably at 6-7.5, ensuring the optimum pH for the most efficient degradation of the organic waste during composting.

13. The activated aerobic composting media according to claim 1, wherein the said composting media is hydrated with sufficient amount of water with respect to the moisture level of the waste and mixed with the organic waste and, allowed to ferment for a required amount of time to produce a high-quality organic manure with a pleasant odour and easy to handle properties.

14. The activated aerobic composting media according to claim 1, wherein the moisture level of the hydrated composting media is maintained at 20 to 60%, more preferably 30 to 60% to accommodate various organic waste with different moisture level and to eliminate the need of frequent watering during composting of the organic waste.

15. The activated aerobic composting media according to claim 1, wherein the said time required for the complete composting/bio-degradation of the organic waste is preferably 10 to 40 days, more preferably 20 to 35 days.

16. The activated aerobic composting media as claimed in claim 1, results in a accelerated, hassle-free, convenient, odour-free, leachate-free composting process, without generating any toxic gases during composting.

17. The method of preparation of the activated aerobic composting media according to claim 6, wherein the said nutritive amendments ranges from 0-20 wt % of the composting media, more preferably 0-10 Wt %.
